(19) United States
(12) Patent Application Publication
(10) Pub. No.: US 2007/0207364 A1
(43) Pub. Date: Sep. 6, 2007

(54) Fuel cells comprising moldable gaskets, and methods of making

(76) Inventors: Mahmoud H. Abd Elhamid, Grosse Pointe Woods, MI (US); Youssef M. Mikhail, Sterling Heights, MI (US); Daniel J. Lisi, Eastpointe, MI (US); Gayatri Vyas, Rochester Hills, MI (US)

Correspondence Address: CARY W. BROOKS;General Motors Corporation, Mail Code 482-C23-B21, Legal Staff, P.O. Box 300, Detroit, MI, 48265-3000, US

(21) Appl. No.: 11/368,057

(22) Filed: Mar. 3, 2006

(51) Int. Cl. H01M 2/08; H01M 8/24; B05D 5/12

(52) U.S. Cl. 429/36; 427/115; 29/623.2

(57) ABSTRACT

Devices comprising an electrochemical conversion assembly comprise a plurality of electrochemical conversion cells, and a plurality of electrically conductive bipolar plates, wherein the electrochemical conversion cells are disposed between the adjacent bipolar plates. The electrochemical conversion assembly further comprises a plurality of conversion assembly gaskets, wherein the respective conversion assembly gaskets are molded onto corresponding ones of the plurality of bipolar plates. The conversion assembly gaskets comprise a mixture including polyvinylidene fluoride (PVDF).

### FIELD OF THE INVENTION

The present invention relates generally to electrochemical conversion cells, and specifically electrochemical conversion cells disposed between bipolar plates.

### BACKGROUND OF THE INVENTION

Electrochemical conversion cells, commonly referred to as fuel cells, which produce electrical energy by processing first and second reactants, e.g., through oxidation and reduction of hydrogen and oxygen. By way of illustration and not limitation, a typical polymer electrolyte fuel cell comprises a polymer membrane (e.g., a proton exchange membrane) that is positioned between a pair of gas diffusion media layers and catalyst layers. A cathode plate and an anode plate are positioned at the outermost sides adjacent the gas diffusion media layers, and the preceding components are tightly compressed to form the cell unit.

The voltage provided by a single cell unit is typically too small for useful applications. Accordingly, a plurality of cells are typically arranged and connected consecutively in a “stack” to increase the electrical output of the electrochemical conversion assembly or fuel cell. In this arrangement, two adjacent cell units can share a common polar plate, which serves as the anode and the cathode for the two adjacent cell units it connects in series. Such a plate is commonly referred to as a bipolar plate and typically includes a flow field defined therein to enhance the delivery of reactants and coolant to the associated cells. Bipolar plates for fuel cells are typically required to be electrochemically stable, and electrically conductive.

### SUMMARY OF THE INVENTION

In a first embodiment of the present invention, a device comprising an electrochemical conversion assembly is provided. The electrochemical conversion assembly comprises a plurality of electrochemical conversion cells, and a plurality of electrically conductive bipolar plates, wherein the electrochemical conversion cells are disposed between adjacent bipolar plates. The electrochemical conversion assembly further comprises a plurality of conversion assembly gaskets, wherein the respective conversion assembly gaskets are molded onto corresponding ones of the plurality of bipolar plates. The conversion assembly gaskets comprise a mixture including polyvinylidene fluoride (PVDF).

In a second embodiment of the present invention, a device comprising an electrochemical conversion assembly is provided. The electrochemical conversion assembly comprises a plurality of electrochemical conversion cells, wherein each conversion cell comprises membrane electrode assemblies. The electrochemical conversion assembly further comprises a plurality of electrically conductive bipolar plates, wherein the electrochemical conversion cells are disposed between adjacent bipolar plates. The electrochemical conversion assembly also comprises a plurality of conversion assembly gaskets molded onto the membrane electrode assemblies, wherein the conversion assembly gaskets comprise a mixture including polyvinylidene fluoride (PVDF).

In a third embodiment of the present invention, a method of fabricating an electrochemical conversion assembly is provided. The method comprises providing a plurality of electrochemical conversion cells and a plurality of electrically conductive bipolar plates. The method further comprises forming a mixture comprising polyvinylidene fluoride (PVDF) and a solvent by dissolving the PVDF in the solvent, applying the mixture onto the plurality of bipolar plates, and heating the mixture under pressure at a temperature and duration sufficient to form a plurality of conversion assembly gaskets on the plurality of bipolar plates.

In a fourth embodiment of the present invention, a method of fabricating an electrochemical conversion assembly is provided. The method comprises providing a plurality of electrochemical conversion cells comprising electrode membrane assemblies, and a plurality of electrically conductive bipolar plates. The method further comprises forming a mixture comprising polyvinylidene fluoride (PVDF) and a solvent by dissolving the PVDF in the solvent, applying the mixture onto the membrane electrode assemblies, and heating the mixture under pressure at a temperature and duration sufficient to form a plurality of conversion assembly gaskets on the membrane electrode assemblies.

Other features and advantages of the present invention will be apparent in light of the description of the invention embodied herein.

### BRIEF DESCRIPTION OF THE DRAWINGS

The following detailed description of specific embodiments of the present invention can be best understood when read in conjunction with the following drawings, where like structure is indicated with like reference numerals, where various components of the drawings are not necessarily illustrated to scale, and in which:

FIG. 1 is an illustration of a bipolar plate according to one or more embodiments of the present invention;

FIG. 2 is a cross-sectional illustration of a bipolar plate comprising a gasket thereon according to one or more embodiments of the present invention;

FIG. 3 is a schematic illustration of an electrochemical conversion assembly according to one or more embodiments of the present invention;

FIG. 4 is a schematic illustration of a vehicle having a fuel processing system and an electrochemical conversion assembly according to one or more embodiments of the present invention; and

FIG. 5 is a schematic illustration of a membrane electrode assembly comprising a gasket molded thereon according to one or more embodiments of the present invention.

### DETAILED DESCRIPTION

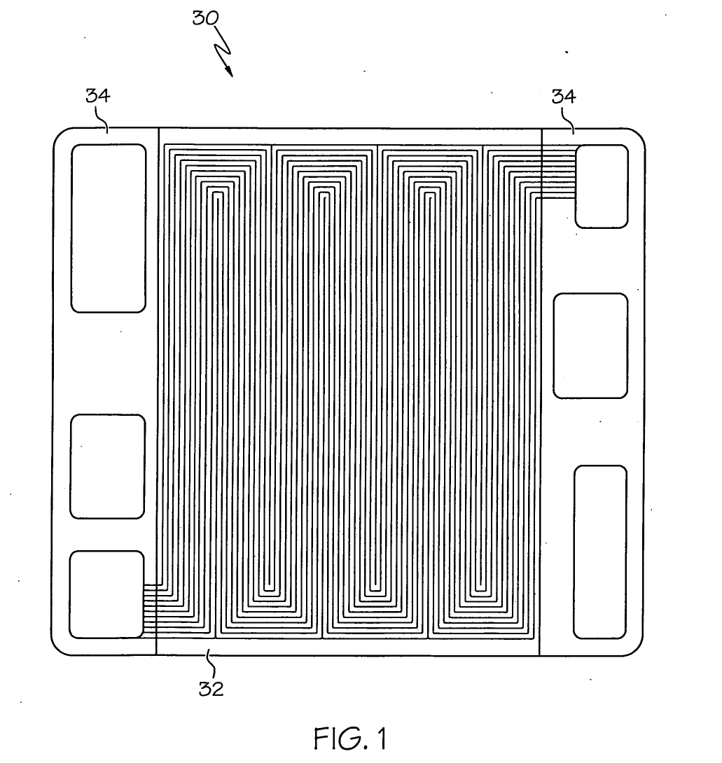

Referring generally to FIGS. 1-5, an electrochemical conversion assembly 10 according to the present invention is illustrated. Generally, the electrochemical conversion assembly 10 comprises a plurality of electrochemical conversion cells 20 and a plurality of electrically conductive bipolar plates 30. The electrochemical conversion cells may comprise polymer exchange membrane (PEM) fuel cells. A variety of conversion assembly configurations are contemplated by the present invention, as long as the assembly utilizes one or more bipolar plates 30 between some or all of the respective electrochemical conversion cells 20. Indeed, the specific structure of the conversion assembly 10 and the individual conversion cells 20, is beyond the scope of the present invention and may be gleaned from any existing or yet to be developed teachings related to the design of an assembly that is capable of generating electricity from first and second chemical reactant supplies R₁, R₂ in communication with the electrochemical conversion cells 20. One or more reactant outlets R_{OUT} are also typically provided.

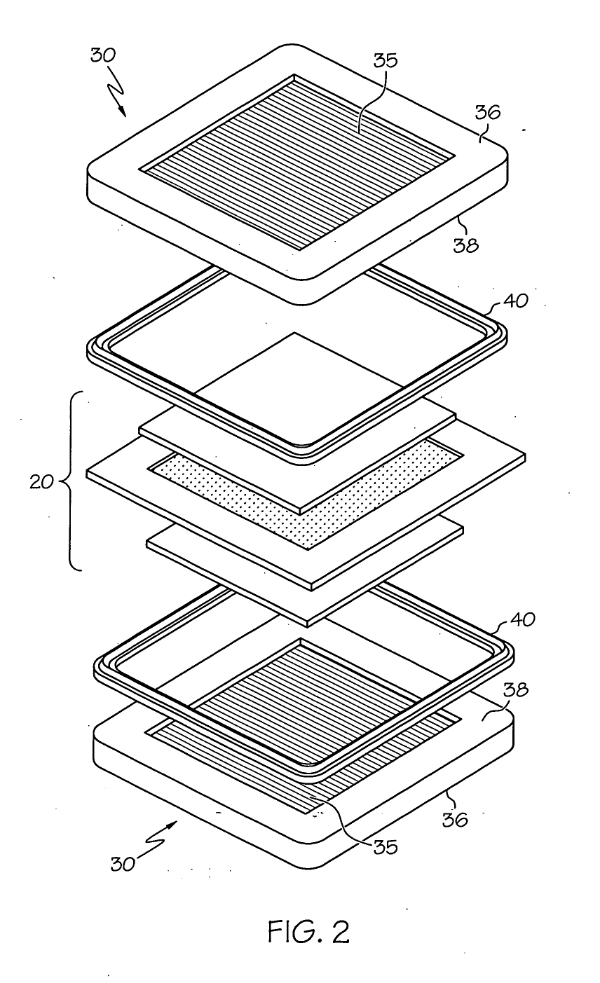

Many aspects of the specific configuration of the bipolar plates 30 according to the present invention are also beyond the scope of the present invention. For example, referring specifically to FIG. 1, a bipolar plate 30 according to the present invention may comprise a flowfield portion 32 and fluid header portions 34 coupled to the flowfield portion 32. As is illustrated in FIG. 2, the flowfield portion 32 can include flowfield channels 35 defined between opposite, electrically conductive sides 36, 38 of the bipolar plate 30.

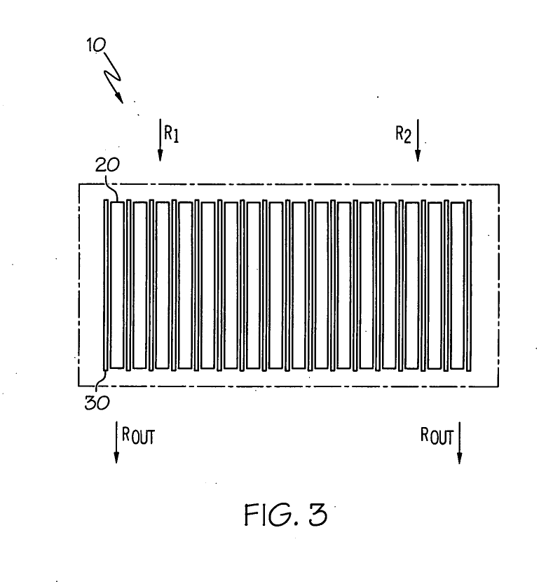

As is illustrated in FIG. 3, adjacent electrochemical conversion cells 20 are separated by respective ones of the plurality of bipolar plates 30. To minimize leakage of the fluid reactant and product streams in the electrochemical conversion assembly, a gasket may act as a seal against leakage. However, gasketing fuel cells is considerably difficult, because the fuel cell's acidic environment attacks metallic and non-metallic materials. Furthermore, the gasket has to be electrochemically stable, compressible, inexpensive, and available.

As shown in FIG. 2, the bipolar plates 30 may comprise conversion assembly gaskets 40 molded onto the bipolar plates 30. The gaskets 40 may be molded on one or both sides 36, 38 of the bipolar plates 30. Referring to the embodiment of FIG. 2, the gasket seal 40 may be molded onto the bipolar plates 30, such that the gasket 40 is disposed between the bipolar plates 30 and the conversion cells 20. In this embodiment, the gasket 40 defines a open substantially rectangular shape dimensioned to seal at least part of the outer perimeter surrounding the flowfield channels 35.

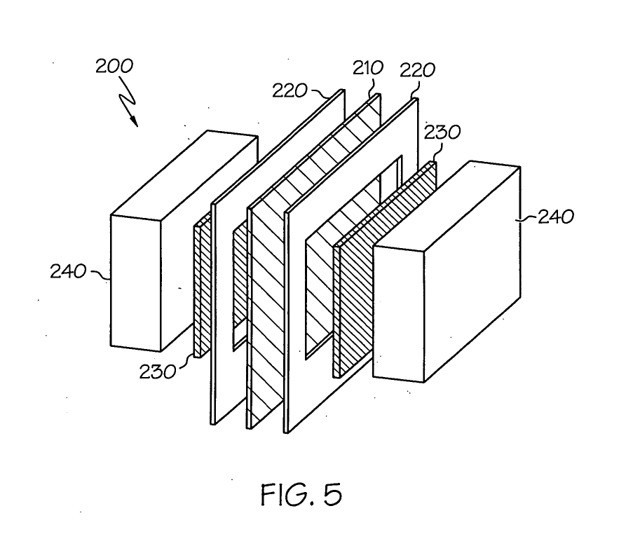

Referring to FIG. 5, the conversion assembly gaskets may also be incorporated into membrane electrode assemblies 200 of electrochemical conversion cells. The membrane electrode assembly 200 may comprise multiple layer arrangements, for example, the 7 layer arrangement of FIG. 5, thus the placement of the gasket seal may vary. As shown in FIG. 5, at least one gasket membrane 220 is molded onto membrane 210. In this embodiment, the gasket 220 defines an open substantially rectangular shape dimensioned to seal the outer perimeter of the membrane 210. The membrane electrode assembly 200 may further comprise at least one electrode layer 230 and at least one gas dispersion layer 240. FIG. 5 illustrates a 2 electrode layers, one comprising an anode layer, and the other a cathode layer. In one exemplary embodiment as shown in FIG. 5, the electrode layer 230 and gas dispersion layer 240 are disposed within the opening of the gasket 220 to facilitate reactant flow through the membrane electrode assembly 200. In a further embodiment, the electrochemical conversion assembly 10 may comprise gaskets on the bipolar plates, and membranes as shown in FIGS. 2 and 5. In addition to the gaskets described herein, other gasket shapes, sizes and configurations known to one skilled in the art are contemplated herein.

The conversion assembly gaskets comprise a mixture including polyvinylidene fluoride (PVDF). In one embodiment, the mixture comprises a PVDF homopolymer, for example,

Hylar® 461, which is produced by Solvay Solexis®. In yet another embodiment, the mixture comprises at least one solvent. The solvent may comprise any suitable material effective to dissolve a PVDF material. In an exemplary embodiment, the solvent is a carbonate solvent comprising propylene carbonate, ethylene carbonate, or combinations thereof. The PVDF material may be selected such that it dissolves well in carbonates. Upon dissolving, a paste is formed, which may be molded on or onto a membrane of an electrode membrane assembly or a bipolar plate. For example, and not by way of limitation, the paste may comprise a composition of 60% by wt. PVDF homopolymer, and 40% by wt. propylene carbonate.

It is contemplated that any suitable PVDF material may be used; however, a PVDF homopolymer, such as Hylar® 461, may provide additional benefits. Unlike typical fluorocarbons, Hylar® dissolves in an ethylene/propylene carbonate, which enables Hylar® to be injection molded into a bipolar plate. Further, since it is from the Teflon family, it is chemically inert and can be applied directly to the membrane of the MEA.

In contrast, Hylar® has superior chemical stability which facilitates its effectiveness in the gasket. Hylar® has a density of about 1.76 cm³ and a melting point of about 158 to about 160° C. Hylar® exhibits excellent thermal stability. For example, at high temperatures, Hylar® only exhibits a 1% mass loss in N₂ at a temperature of 410° C. High temperature stability enables Hylar to be used as a gasket material in high temperature proton exchange membrane fuel cell stacks, wherein Hylar gaskets may contact membranes with operating temperatures of between about 120° C. to about 150° C., and temperatures much greater.

Hylar® also is thermally stable at lower temperatures, e.g. at temperatures below freezing. For example, Hylar® exhibits a glass transition temperature of about −39° C. Hylar® is also desirable for use in a gasket seal because it is an electrically insulating material. For example, Hylar® has a volume resistivity of about 1×10¹⁵ ohm-cm at 23° C., and a dielectric strength of about 6 kV/mm. Unlike other fluoropolymers or other gaskets such as rubber or silicone based gaskets, Hylar® is chemically inert. For example, Hylar® does not react or absorb water as demonstrated by a water absorption of only about 0.02% by weight. Since the Hylar® will typically be compressed in a fuel cell gasket, the water absorption of the gasket may be even less than 0.02% by weight. Furthermore, Hylar® exhibits sound mechanical properties, which contribute to its long term stability. For instance, Hylar® exhibits an elongation at breakage of about 100%, and an elongation at yield of about 10%. Moreover, Hylar® has a tensile modulus of about 190000 psi or about 1310 Mpa.

Fabricating an electrochemical conversion assembly, wherein a gasket 40 is provided on the bipolar plate 30 as in FIG. 2, or wherein a gasket 220 is provided on the membrane 210 as in FIG. 5, may utilize various methods known to one skilled in the art. In one embodiment, the method comprises providing a plurality of electrochemical conversion cells and a plurality of electrically conductive bipolar plates, and forming a mixture comprising polyvinylidene fluoride (PVDF) and a solvent by dissolving the PVDF in the solvent. As described above, many feasible PVDF/solvent compositions are feasible, for example, a paste formulation comprising PVDF homopolymer Hylar® 461 dissolved in propylene or ethylene carbonate. The mixture may then applied onto the plurality of bipolar plates or membrane electrode assemblies. The mixture may be applied via any suitable application or deposition method known to one skilled in the art, for example, screen printing and brushing. In one exemplary embodiment, the mixture is molded onto the bipolar plates or membrane electrode assemblies through an injection molding process. After application, the mixture is heated under pressure at a temperature and duration sufficient to form a plurality of conversion assembly gaskets on the plurality of bipolar plates, on the membrane electrode assemblies, or on both. During heating, the temperature may range between about 150° C. to about 200° C. with a duration of up to about 5 hours. The pressure may be applied through a hot press, or any other suitable pressure application device known to one skilled in the art. In one exemplary embodiment, a paste mixture comprising Hylar® 461 and propylene carbonate was formed into a gasket by hot pressing the mixture for 3 minutes at 160° C. Other processing parameters and/or steps are also contemplated herein.

As is noted above, the specific structure of the conversion assembly 10 and the individual conversion cells 20, is beyond the scope of the present invention. However, it is noted that typical conversion assemblies comprise respective membrane electrode assemblies that are configured to operate with hydrogenous gas and air as the respective reactant supplies. Again by way of illustration and not limitation, the electrochemical conversion cells 20 may comprise respective electrolytic membranes, gaseous diffusion layers, catalytic components, carbonaceous components, electrically conductive components, and combinations thereof. Finally, although the bipolar plates 30 illustrated in FIGS. 1 and 2 comprise a flowfield defined between the opposite, electrically conductive sides of the bipolar plate 30, it is contemplated that suitable bipolar plate configurations need not include a flowfield.

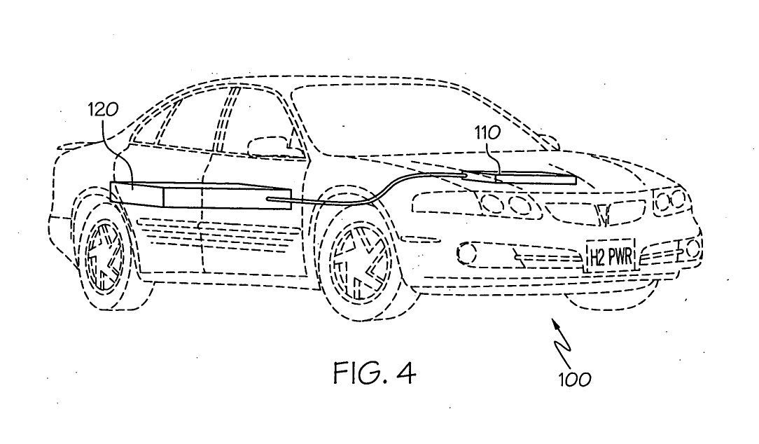

Referring to FIG. 4, a device according to the present invention may comprise a vehicle 100 and an electrochemical conversion assembly 110 according to the present invention. The electrochemical conversion assembly 110 can be configured to at least partially provide the vehicle 100 with motive power. The vehicle 100 may also have a fuel processing system or fuel source 120 configured to supply the electrochemical conversion assembly 110 with fuel.

Although the present invention is not limited to any specific reactant compositions, it will be appreciated by those practicing the present invention and generally familiar with fuel cell technology that the first reactant supply R₁ typically comprises oxygen and nitrogen while the second reactant supply R₂ comprises hydrogen.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “device” is utilized herein to represent a combination of components and individual components, regardless of whether the components are combined with other components. For example, a “device” according to the present invention may comprise an electrochemical conversion assembly or fuel cell, a vehicle incorporating an electrochemical conversion assembly according to the present invention, etc.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A device comprising an electrochemical conversion assembly, the electrochemical conversion assembly comprising:
a plurality of electrochemical conversion cells;
a plurality of electrically conductive bipolar plates, the electrochemical conversion cells being disposed between adjacent bipolar plates; and
a plurality of conversion assembly gaskets, wherein respective conversion assembly gaskets are molded onto corresponding ones of the plurality of bipolar plates, and the conversion assembly gaskets comprise a mixture including polyvinylidene fluoride (PVDF).

2. A device according to claim 1 wherein the mixture comprises a PVDF homopolymer.

3. A device according to claim 2 wherein the PVDF homopolymer comprises a density of about 1.76 cm³.

4. A device according to claim 2 wherein the PVDF homopolymer comprises a melting point of about 158 to about 160° C.

5. A device according to claim 2 wherein the PVDF homopolymer exhibits about a 1% mass loss in N₂ at a temperature of 410° C.

6. A device according to claim 2 wherein the PVDF homopolymer exhibits a glass transition temperature of about −39° C.

7. A device according to claim 2 wherein the PVDF homopolymer comprises a volume resistivity of about 1×10¹⁵ ohm-cm at 23° C.

8. A device according to claim 2 wherein the PVDF homopolymer comprises a dielectric strength of about 6 kV/mm.

9. A device according to claim 2 wherein the PVDF homopolymer comprises a maximum water absorption of about 0.02% by weight.

10. A device according to claim 2 wherein the PVDF homopolymer comprises an elongation at breakage of about 100%, and an elongation at yield of about 10%.

11. A device according to claim 2 wherein the PVDF homopolymer comprises a tensile modulus of about 1310 Mpa.

12. A device according to claim 1 wherein the mixture comprises at least one solvent.

13. A device according to claim 12 wherein the solvent is a carbonate solvent comprising propylene carbonate, ethylene carbonate, or combinations thereof.

14. A device according to claim 1 wherein the mixture comprises 60% by wt. PVDF homopolymer and 40% by wt. propylene carbonate.

15. A device according to claim 1 wherein the bipolar plates comprise a flowfield defined between opposite, electrically conductive sides of the bipolar plate.

16. A device according to claim 1 wherein the electrochemical conversion cells further comprise respective membrane electrode assemblies, electrolytic membranes, gaseous diffusion layers, catalytic components, carbonaceous components, electrically conductive components, and combinations thereof.

17. A device according to claim 1 further comprising a fuel processing system or fuel source for providing a hydrogenous gas to the electrochemical conversion assembly.

18. A device according to claim 1 wherein
the device is a vehicle; and
the electrochemical conversion assembly is configured to at least partially provide the vehicle with motive power.

19. A device comprising an electrochemical conversion assembly, the electrochemical conversion assembly comprising:
a plurality of electrochemical conversion cells, wherein each conversion cell comprises membrane electrode assemblies;
a plurality of electrically conductive bipolar plates, the electrochemical conversion cells being disposed between adjacent bipolar plates; and
a plurality of conversion assembly gaskets molded onto the membrane electrode assemblies, wherein the conversion assembly gaskets comprise a mixture including polyvinylidene fluoride (PVDF).

20. A device according to claim 19 wherein the membrane electrode assemblies comprise at least one polymer electrolyte layer, at least one anode layer and at least one cathode layer.

21. A device according to claim 19 further comprising conversion assembly gaskets molded onto the plurality of bipolar plates.

22. A method of fabricating an electrochemical conversion assembly comprising:
providing a plurality of electrochemical conversion cells and a plurality of electrically conductive bipolar plates;
forming a mixture comprising polyvinylidene fluoride (PVDF) and a solvent by dissolving the PVDF in the solvent;
applying the mixture onto the plurality of bipolar plates; and
heating the mixture under pressure at a temperature and duration sufficient to form a plurality of conversion assembly gaskets on the plurality of bipolar plates.

23. A method according to claim 22 wherein the gaskets are applied through an injection molding process.

24. A method according to claim 22 wherein the temperature is between about 150° C. to about 200° C.

25. A method according to claim 22 wherein the duration is up to about 5 hours.

26. A method according to claim 22 wherein the pressure is applied through a hot press.

27. A method of fabricating an electrochemical conversion assembly comprising:
providing a plurality of electrochemical conversion cells comprising electrode membrane assemblies, and a plurality of electrically conductive bipolar plates;
forming a mixture comprising polyvinylidene fluoride (PVDF) and a solvent by dissolving the PVDF in the solvent;
applying the mixture onto the membrane electrode assemblies; and
heating the mixture under pressure at a temperature and duration sufficient to form a plurality of conversion assembly gaskets on the membrane electrode assemblies.

28. A method according to claim 27 further comprising,
applying the mixture onto the plurality of bipolar plates; and
heating the mixture under pressure at a temperature and duration sufficient to form a plurality of conversion assembly gaskets on the plurality of bipolar plates.
